(19) United States
(12) Patent Application Publication
(10) Pub. No.: US 2014/0067222 A1
(43) Pub. Date: Mar. 6, 2014

(54) CONTROL APPARATUS AND METHOD FOR BRAKE

(71) Applicant: MANDO CORPORATION, Pyeongtaek-si (KR)

(72) Inventors: Gyung-Hun SIM, Anyang-Si (KR); I Jin YANG, Seongnam-si (KR); Kyu Woong CHOI, Pyeongtaek-si (KR)

(73) Assignee: MANDO CORPORATION, Pyeongtaek-si (KR)

(21) Appl. No.: 14/018,372

(22) Filed: Sep. 4, 2013

(30) Foreign Application Priority Data
Sep. 4, 2012 (KR) 10-2012-0097411

(51) Int. Cl. B60T 8/17; B60T 7/06

(52) U.S. Cl. CPC B60T 8/17; B60T 7/06
USPC 701/70

(57) ABSTRACT

Disclosed herein are a brake control apparatus and methods for controlling of a brake. The brake control apparatus includes a wheel pressure selector to select one of different wheel pressure modes for a current pedal stroke produced in a brake system during driving, a wheel pressure storage unit to store information on different levels of wheel pressure corresponding to the different wheel pressure modes, a first controller to receive a wheel pressure mode signal corresponding to one of the wheel pressure modes selected through the wheel pressure selector and to receive corresponding wheel pressure information from the wheel pressure storage unit, and a first wheel pressure adjuster to supply the corresponding wheel pressure information to brake system to adjust a current wheel pressure for the current pedal stroke produced in the brake system to the corresponding wheel pressure information stored in the wheel pressure storage unit.

### CROSS-REFERENCE TO RELATED APPLICATION(S)

This application claims the benefit of Korean Patent Application No. 2012-0097411, filed on Sep. 4, 2012 in the Korean Intellectual Property Office, the disclosure of which is incorporated herein by reference.

### BACKGROUND

1. Field

Embodiments of the present invention relate to a control apparatus for controlling of a brake and methods for controlling thereof.

2. Description of the Related Art

A conventional brake control apparatus is generally designed to control current wheel pressure according to a current pedal stroke produced in the brake system during driving of a vehicle.

In the case of the conventional brake control apparatus, current wheel pressure needs to be controlled for a current pedal stroke produced in the brake system, depending on the driver's experience. Accordingly, reducing power consumption and battery consumption for control of the vehicle with the conventional brake control apparatus may have a limit. In addition, the conventional brake control apparatus may have a limit in improving braking efficiency and driving efficiency in relation to riding comfort.

Therefore, a research has been continuously conducted on a brake control apparatus which is capable of reducing power consumption and battery consumption for control of the vehicle, improving braking efficiency and driving efficiency in consideration of riding comfort, and providing the driver with comfortable ride and a brake control method.

### SUMMARY

Therefore, it is an aspect of the present invention to provide a brake control apparatus that may reduce power consumption and battery consumption for control of a vehicle, and improve braking efficiency and driving efficiency in relation to riding comfort, and a control method thereof.

It is another aspect of the present invention to provide a brake control apparatus that may provide the driver with comfortable ride and a control method thereof.

Additional aspects of the invention will be set forth in part in the description which follows and, in part, will be obvious from the description, or may be learned by practice of the invention.

In accordance with one aspect of the present invention, a brake control apparatus includes a wheel pressure selector to select one of a plurality of different wheel pressure modes for a current pedal stroke produced in a brake system during driving of a vehicle, a wheel pressure storage unit to store information on a plurality of different levels of wheel pressure corresponding to the different wheel pressure modes, a first controller to receive a wheel pressure mode signal corresponding to one of the wheel pressure modes selected through the wheel pressure selector and to control the wheel pressure storage unit to receive corresponding wheel pressure information from the wheel pressure storage unit, and a first wheel pressure adjuster to supply the corresponding wheel pressure information stored in the wheel pressure storage unit to brake system according to control by the first controller to adjust a current wheel pressure for the current pedal stroke produced in the brake system to the corresponding wheel pressure information stored in the wheel pressure storage unit.

The first controller may include a range of a pedal stroke on a reference road condition according to a predetermined reference weight and reference speed of the vehicle, the brake control apparatus further including a pedal stroke sensing unit to sense a pedal stroke on a current road condition according to a current weight and current speed of the vehicle during driving of the vehicle, a first determination unit to determine, according to control by the first controller, whether the pedal stroke on the current road condition according to the current weight and current speed of the vehicle sensed by the pedal stroke sensing unit is within the range of the pedal stroke on the reference road condition according to the reference weight and reference speed of the vehicle, and a first indication unit to indicate, when the pedal stroke on the current road condition according to the current weight and current speed of the vehicle determined by the first determination unit is within the range of the pedal stroke on the reference road condition according to the reference weight and reference speed of the vehicle, a corresponding wheel pressure mode of the wheel pressure selector to allow selecting of the corresponding wheel pressure mode.

The brake control apparatus may further include a wheel pressure setting unit to set and store, according to control by the first controller, wheel pressure information on another level of wheel pressure corresponding to another wheel pressure mode in the wheel pressure storage unit in accordance with a preference of a driver of the vehicle, wherein the anther wheel pressure mode set by the wheel pressure setting unit is selectable through the wheel pressure selector.

In accordance with another aspect of the present invention, a brake control apparatus includes a wheel pressure sensing unit to sense a current wheel pressure for a current pedal stroke produced in a brake system on a current road condition according to a weight and speed of a vehicle during driving of the vehicle, a second controller to receive a current wheel pressure for the current pedal stroke sensed by the wheel pressure sensing unit, the second controller including wheel pressure information corresponding to a range of a reference wheel pressure for a predetermined reference pedal stroke, a second determination unit to determine, according to control by the second controller, whether the current wheel pressure for the current pedal stroke sensed by the wheel pressure sensing unit is within the range of the reference wheel pressure for the reference pedal stroke, and a second wheel pressure adjuster to supply, when the current wheel pressure for the current pedal stroke determined by the second determination unit is within the range of the reference wheel pressure for the reference pedal stroke, the wheel pressure information corresponding to the range of the reference wheel pressure for the reference pedal stroke to the brake system to the brake system according to control by the second controller to adjust the current wheel pressure for the current pedal stroke produced in the brake system to the wheel pressure information according to control by the second controller.

The brake control apparatus may further include a second indication unit to indicate a condition for a wheel pressure corresponding to the wheel pressure information when the current wheel pressure for the current pedal stroke determined by the second determination unit is within the range of the reference wheel pressure for the reference pedal stroke.

In accordance with another aspect of the present invention, a method of controlling a brake includes a wheel pressure selecting operation of selecting one of a plurality of different wheel pressure modes for a current pedal stroke produced in a brake system during driving of a vehicle, using a wheel pressure selector, and a first wheel pressure adjusting operation of receiving, by a first controller, a wheel pressure mode signal corresponding to one of the wheel pressure modes selected through the wheel pressure selector, receiving, by the first controller, wheel pressure information corresponding to the selected one of one of the wheel pressure modes from a wheel pressure storage unit, supplying, a first wheel pressure adjuster, the corresponding wheel pressure information stored in the wheel pressure storage unit to the brake system to adjust a current wheel pressure for the current pedal stroke produced in the brake system to the corresponding wheel pressure information stored in the wheel pressure storage unit according to control by the first controller.

The first controller may include a range of a pedal stroke on a reference road condition according to a reference weight and reference speed of the vehicle, the method further including a pedal stroke sensing operation of sensing, by a pedal stroke sensing unit, a pedal stroke on a current road condition according to a current weight and current speed of the vehicle during driving of the vehicle, a first determination operation of determine, by a first determination unit, whether the pedal stroke on the current road condition according to the current weight and current speed of the vehicle sensed by the pedal stroke sensing unit is within the range of the pedal stroke on the reference road condition according to the reference weight and reference speed of the vehicle according to control by the first controller, and a first indication operation of indicating, by a first indication unit when the pedal stroke on the current road condition according to the current weight and current speed of the vehicle determined by the first determination unit is within the range of the pedal stroke on the reference road condition according to the reference weight and reference speed of the vehicle, a corresponding wheel pressure mode of the wheel pressure selector to allow selecting of the corresponding wheel pressure mode, wherein the pedal stroke sensing operation, the first determination operation, and the first indication operation may be performed prior to the wheel pressure selecting operation.

The method may further include a wheel pressure setting operation of setting and storing, by a wheel pressure setting unit, wheel pressure information on another level of wheel pressure corresponding to another wheel pressure mode in the wheel pressure storage unit in accordance with a preference of a driver of the vehicle, according to control by the first controller, wherein the wheel pressure setting operation may be performed prior to the wheel pressure selecting operation, wherein the anther wheel pressure mode set by the wheel pressure setting unit is selectable through the wheel pressure selector.

In accordance with a further aspect of the present invention, a method of controlling a brake includes a wheel pressure sensing operation of sensing, by a wheel pressure sensing unit, a current wheel pressure for a current pedal stroke produced in a brake system on a current road condition according to a weight and speed of a vehicle during driving of the vehicle, a second determination operation of determining, by a second determination unit, whether the current wheel pressure for the current pedal stroke sensed by the wheel pressure sensing unit is within a range of a reference wheel pressure for a predetermined reference pedal stroke set in a second controller, according to control by the second controller, and a second wheel pressure adjusting operation of supplying, by a second wheel pressure adjuster when the current wheel pressure for the current pedal stroke determined by the second determination unit is within the range of the reference wheel pressure for the reference pedal stroke, the wheel pressure information corresponding to the range of the reference wheel pressure for the reference pedal stroke to the brake system to the brake system according to control by the second controller to adjust the current wheel pressure for the current pedal stroke produced in the brake system to the wheel pressure information according to control by the second controller

The method may further include a second indication operation of indicating, by a second indication unit, a condition for a wheel pressure corresponding to the wheel pressure information when the current wheel pressure for the current pedal stroke determined by the second determination unit is within the range of the reference wheel pressure for the reference pedal stroke, wherein the second indication operation may be performed after the second determination operation.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a block diagram illustrating a brake control apparatus according to a first embodiment of the present invention and a brake system connected thereto;

FIG. 2 is a block diagram illustrating an example of the brake control apparatus shown in FIG. 1;

FIG. 3 is a front view illustrating an example of a wheel pressure selector shown in FIG. 2;

FIG. 4 is a graph showing a wheel pressure-pedal stroke curve produced in a normal mode of the first wheel pressure adjuster shown in FIG. 2 and an example of the wheel pressure-pedal stroke curve according selection of the first wheel pressure mode;

FIG. 5 is a flowchart illustrating a brake control method according to the first embodiment;

FIG. 6 is a block diagram illustrating an example of a brake control apparatus according to a second embodiment of the present invention;

FIG. 7 is a flowchart illustrating a brake control method according to the second embodiment;

FIG. 8 is a flowchart illustrating an example of the brake control method according to the second embodiment;

FIG. 9 is a block diagram illustrating an example of a brake control apparatus according to a third embodiment of the present invention;

FIG. 10 is a front view illustrating an example of the wheel pressure selector shown in FIG. 9;

FIG. 11 is a flowchart illustrating a brake control method according to the third embodiment;

FIG. 12 is a block diagram illustrating a brake control apparatus according to a fourth embodiment of the present invention and a brake system connected thereto;

FIG. 13 is a block diagram illustrating an example of the brake control apparatus shown in FIG. 12;

FIG. 14 is a graph showing a wheel pressure-normal pedal stroke curve in the second wheel pressure adjuster shown in FIG. 13 and an example of the wheel pressure-pedal stroke curve produced by the second wheel pressure adjuster;

FIG. 15 is a flowchart illustrating a brake control method according to a fourth embodiment of the present invention;

FIG. 16 is a flowchart illustrating an example of the brake control method according to the fourth embodiment;

FIG. 17 is a block diagram illustrating an example of a brake control apparatus according to a fifth embodiment of the present invention;

FIG. 18 is a flowchart illustrating a brake control method according to the fifth embodiment; and

FIG. 19 is a flowchart illustrating an example of the brake control method according to the fifth embodiment;

### DETAILED DESCRIPTION

Reference will now be made in detail to the embodiments of the present invention, examples of which are illustrated in the accompanying drawings, wherein like reference numerals refer to like elements throughout.

### First Embodiment

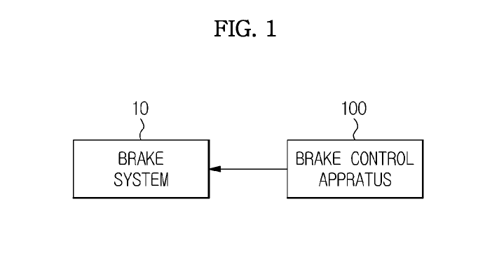

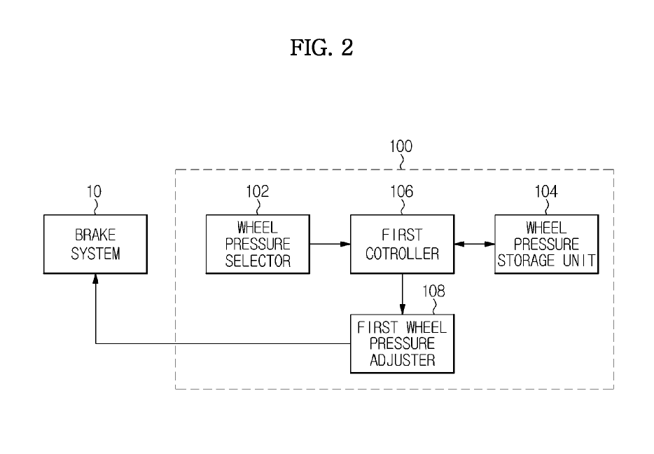

FIG. 1 is a block diagram illustrating a brake control apparatus according to a first embodiment of the present invention and a brake system connected thereto, and FIG. 2 is a block diagram illustrating an example of the brake control apparatus shown in FIG. 1.

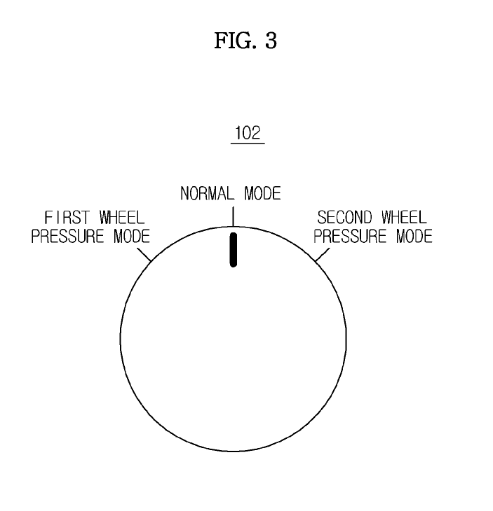

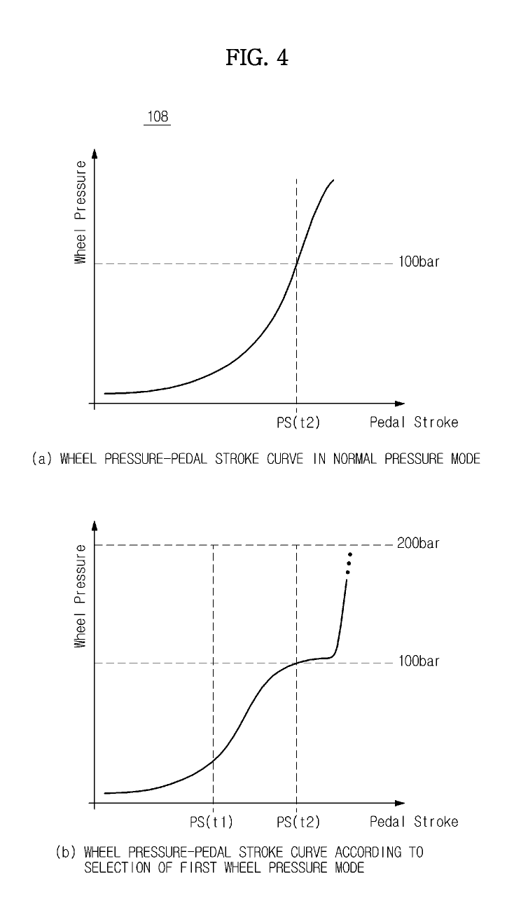

FIG. 3 is a front view illustrating an example of a wheel pressure selector shown in FIG. 2, and FIG. 4 is a graph showing a wheel pressure-pedal stroke curve produced in a normal mode of the first wheel pressure adjuster shown in FIG. 2 and an example of the wheel pressure-pedal stroke curve according selection of the first wheel pressure mode.

Referring to FIGS. 1 to 4, a brake control apparatus 100 according to the first embodiment includes a wheel pressure selector 102, a wheel pressure storage unit 104, a first controller 106, and a first wheel pressure adjuster 108.

The wheel pressure selector 102 allows selecting one of different wheel pressure modes for a current pedal stroke produced in a brake system 10 during driving of a vehicle.

For example, the wheel pressure selector 102 may allow selection of one of a normal mode, a first wheel pressure mode, and a second wheel pressure mode for a current pedal stroke produced in a brake system 10 during driving of a vehicle, as shown in FIG. 3.

Herein, the first wheel pressure mode may be a mode providing wheel pressure of a level higher than the level of wheel pressure in the normal mode, and the second wheel pressure mode may be a mode providing wheel pressure of a level lower than the level of wheel pressure in the normal mode.

Herein, the wheel pressure selector 102 may be provided with a rotational lever allowing selection of different wheel pressure modes.

However, embodiments of the present invention are not limited thereto. Although not shown in FIG. 3, the different wheel pressure modes may be selected through the operation of one of a push button switch (not shown) and a finger button sensing switch (not shown).

Herein, although not shown in FIG. 3, the wheel pressure selector 102 may be arranged at one side of the vehicle (not shown) where the wheel pressure selector 102 does not disturb driving of the vehicle but is easily reachable by the driver's hand.

The wheel pressure storage unit 104 is adapted to store information on different levels of wheel pressure corresponding to the different wheel pressure modes.

The first controller 106 receives a wheel pressure mode signal corresponding to one of the wheel pressure modes selected through the wheel pressure selector 102, and performs a control operation to receive the corresponding wheel pressure information from the wheel pressure storage unit 104.

The first wheel pressure adjuster 108 supplies, according to control by the first controller 106, the corresponding wheel pressure information stored in the wheel pressure storage unit 104 to the brake system 10 to adjust the current wheel pressure for a current pedal stroke produced in the brake system 10 to the corresponding wheel pressure information stored in the wheel pressure storage unit 104.

When one of the wheel pressure modes proper for the pedal stroke according to the current weight and speed of the vehicle on at least one of the current road conditions including urban driving, highway driving, level road, and inclined road is selected through the wheel pressure selector 102 during driving, the first wheel pressure adjuster 108 may supply the corresponding wheel pressure information stored in the wheel pressure storage unit 104 to the brake system 10 to adjust the current wheel pressure for a current pedal stroke produced in the brake system 10 to the corresponding wheel pressure information stored in the wheel pressure storage unit 104.

For example, as shown in FIG. 4, when the first wheel pressure mode is selected for the pedal stroke according to the current weight and speed of the vehicle on at least one of the current road conditions including urban driving, highway driving, level road, and inclined road through the wheel pressure selector 102 during driving, the first wheel pressure adjuster 108 may supply, to the brake system 10, the wheel pressure information including a wheel pressure curve (FIG. 4(b)) stored in the wheel pressure storage unit 104 to adjust the current wheel pressure for a current pedal stroke produced in the brake system 10 to the wheel pressure information including the wheel pressure curve (FIG. 4(b)) stored in the wheel pressure storage unit 104. Referring to the wheel pressure curve (FIG. 4(b)), the wheel pressure for the pedal stroke [PS(t1)-PS(t2)] is gradually restrained for a certain time and after the certain time elapses, the wheel pressure for the pedal stroke [PS(t2)] is drastically increased.

At this time, the wheel pressure information may include a wheel pressure curve (FIG. 4(b)), in which the wheel pressure for the pedal stroke [PS(t1)-PS(t2)] is gradually restrained for a certain time in the range between 0 bar and 100 bar at which wheel lock is applied, and after the certain time elapses, the wheel pressure for the pedal stroke [PS(t2)] is drastically increased up to 200 bar.

Meanwhile, when the second wheel pressure mode is selected through the wheel pressure selector 102 during driving, which is not shown in FIG. 4, for the pedal stroke according to the current weight and speed of the vehicle on at least one of the current road conditions including urban driving, highway driving, level road, and inclined road, the first wheel pressure adjuster 108 may supply, to the brake system 10, wheel pressure information stored in the wheel pressure storage unit 104 including levels of wheel pressure lower than the level of the wheel pressure in the normal mode to adjust current wheel pressure for a current pedal stroke produced in the brake system 10 to the wheel pressure information including levels of wheel pressure lower than the wheel pressure level in the normal mode, stored in the wheel pressure storage unit 104.

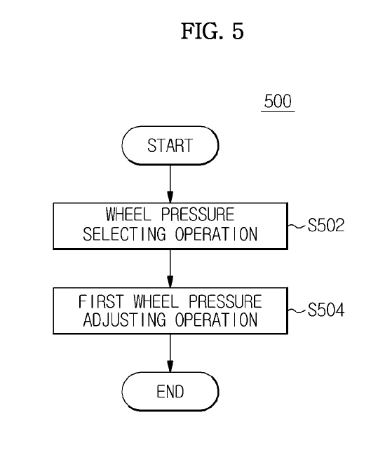

A control method to control a brake using the brake control apparatus 100 according to the first embodiment is illustrated in FIG. 5.

FIG. 5 is a flowchart illustrating a brake control method according to the first embodiment.

Referring to FIG. 5, the brake control method 500 according to the first embodiment includes a wheel pressure selecting operation S502 and a first wheel pressure adjusting operation S504.

First, in the wheel pressure selecting operation S502, different wheel pressure modes are selected for a current pedal stroke produced in the brake system 10 (see FIGS. 1 and 2) during driving, using the wheel pressure selector 102 (see FIG. 2).

For example, in the wheel pressure selecting operation S502, one of the normal mode, the first wheel pressure mode, and the second wheel pressure mode may be selected for a current pedal stroke produced in the brake system 10 (see FIGS. 1 and 2) during driving, using the wheel pressure selector 102 (see FIG. 3).

Herein, in the wheel pressure selecting operation S502, the first wheel pressure mode may provide wheel pressure of a level higher than the level of wheel pressure in the normal mode, and the second wheel pressure mode may provide wheel pressure of a level lower than the level of wheel pressure in the normal mode.

In the wheel pressure selecting operation S502, different wheel pressure modes may be selected by a rotational lever provided to the wheel pressure selector 102 (see FIG. 3).

However, embodiments of the present invention are not limited thereto. Although not shown in the drawings, the different wheel pressure modes may be selected by operation of one of a push button switch (not shown) and a finger button sensing switch (not shown) in the wheel pressure selecting operation S502.

Although not shown in the drawings, in the wheel pressure selecting operation S502, the wheel pressure selector 102 (see FIG. 3) may be provided at one side of the vehicle (not shown) where the wheel pressure selector 102 does not interfere with driving but is easily reachable by the driver's hand.

Finally, in the first wheel pressure adjusting operation S504, a wheel pressure mode signal corresponding to one of the wheel pressure modes selected through the wheel pressure selector 102 (FIG. 2) is supplied to the first controller 106 (FIG. 2), and the wheel pressure information corresponding to the selected wheel pressure mode is supplied from the wheel pressure storage unit 104 (FIG. 2) to the first controller 106 (FIG. 2).

Thereafter, in the first wheel pressure adjusting operation S504, the first wheel pressure adjuster 108 supplies the corresponding wheel pressure information stored in the wheel pressure storage unit 104 (FIG. 2) to the brake system 10 (FIGS. 1 and 2) according to control by the first controller 106 (FIG. 2) to adjust the current wheel pressure for a current pedal stroke produced in the brake system 10 (FIGS. 1 and 2) to the corresponding wheel pressure information stored in the wheel pressure storage unit 104 (FIG. 2).

In the first wheel pressure adjusting operation S504, when one of the wheel pressure modes proper for the pedal stroke according to the current weight and speed of the vehicle on at least one of the current road conditions including urban driving, highway driving, level road, and inclined road is selected through the wheel pressure selector 102 (FIG. 2) during driving, the first wheel pressure adjuster 108 (FIG. 2) may supply the corresponding wheel pressure information stored in the wheel pressure storage unit 104 (FIG. 2) to the brake system 10 (FIGS. 1 and 2) according to control by the first controller 106 (FIG. 2) to adjust the current wheel pressure for a current pedal stroke produced in the brake system 10 (FIGS. 1 and 2) to the corresponding wheel pressure information stored in the wheel pressure storage unit 104.

For example, in the first wheel pressure adjusting operation S504, when the first wheel pressure mode is selected for the pedal stroke according to the current weight and speed of the vehicle on at least one of the current road conditions including urban driving, highway driving, level road, and inclined road through the wheel pressure selector 102 (FIG. 3) during driving, the first wheel pressure adjuster 108 (FIG. 4) may be controlled by the first controller 106 (FIG. 2) supply, to the brake system 10 (FIGS. 1 and 2), the wheel pressure information including a wheel pressure curve (FIG. 4(b)) stored in the wheel pressure storage unit 104 (FIG. 2) to adjust the current wheel pressure for a current pedal stroke produced in the brake system 10 (FIGS. 1 and 2) to the wheel pressure information including the wheel pressure curve (FIG. 4(b)) stored in the wheel pressure storage unit 104 (FIG. 2). In the wheel pressure curve (FIG. 4(b)), the wheel pressure for the pedal stroke [PS(t1)-PS(t2)] (FIG. 4) is gradually restrained for a certain time and after the certain time elapses, the wheel pressure for the pedal stroke [PS(t2)] (FIG. 4) is drastically increased.

At this time, in the first wheel pressure adjusting operation S504, the wheel pressure information may include a wheel pressure curve (FIG. 4(b)), in which the wheel pressure for the pedal stroke [PS(t1)-PS(t2)] (FIG. 4) is gradually restrained for a certain time in the range between 0 bar and 100 bar at which wheel lock is applied, and after the certain time elapses, the wheel pressure for the pedal stroke [PS(t2)] (FIG. 4) is drastically increased up to 200 bar.

Meanwhile, in the first wheel pressure adjusting operation S504, when the second wheel pressure mode is selected through the wheel pressure selector 102 (FIG. 3) during driving, which is not shown in FIG. 5, for the pedal stroke according to the current weight and speed of the vehicle on at least one of the current road conditions including urban driving, highway driving, level road, and inclined road, the first wheel pressure adjuster (not shown) may be controlled by the first controller 106 (FIG. 2) to supply the wheel pressure information stored in the wheel pressure storage unit 104 (FIG. 2) including levels of wheel pressure lower than the level of the wheel pressure in the normal mode to the brake system 10 (FIGS. 1 and 2) to adjust the current wheel pressure for the current pedal stroke produced in the brake system 10 (FIGS. 1 and 2) to the wheel pressure information including levels of wheel pressure lower than the wheel pressure level in the normal mode, stored in the wheel pressure storage unit 104 (FIG. 2).

The brake control apparatus 100 and control method 500 according to the first embodiment include the wheel pressure selector 102, the wheel pressure storage unit 104, the first controller 106, and the first wheel pressure adjuster 108.

Accordingly, in the brake control apparatus 100 and control method 500 according to the first embodiment, current wheel pressure for a current pedal stroke produced in the brake system 10 is selected in the wheel pressure selector 102, and adjusted to the corresponding wheel pressure information stored in the wheel pressure storage unit 104 by the first wheel pressure adjuster 108 according to the selection signal of the wheel pressure selector 102.

Since the brake control apparatus 100 and control method 500 according to the first embodiment allow adjustment the level of the wheel pressure during driving such that that level is suitable for the pedal stroke on the current road conditions, power consumption and battery consumption for control of the vehicle may be reduced, and braking efficiency and driving efficiency may be improved in consideration of riding comfort.

### Second Embodiment

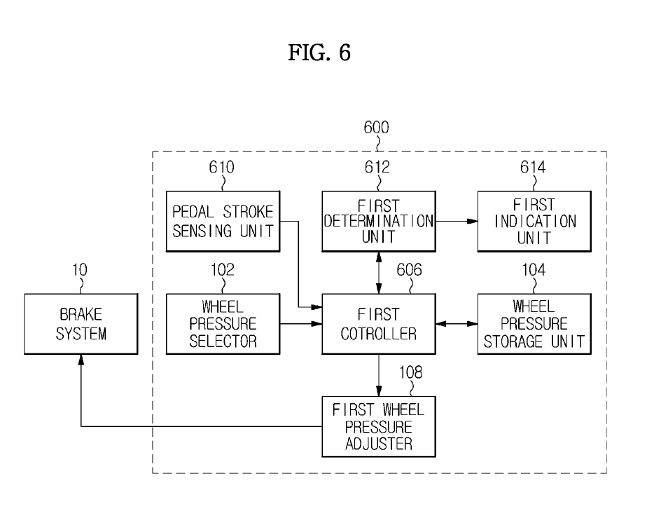

FIG. 6 is a block diagram illustrating an example of a brake control apparatus according to a second embodiment of the present invention.

Referring to FIG. 6, the brake control apparatus 600 according to the second embodiment includes a wheel pressure selector 102, a wheel pressure storage unit 104, a first controller 606, a first wheel pressure adjuster 108, which is similar to the brake control apparatus 100 according to the first embodiment.

Functions of the above constituents of the brake control apparatus 600 according to the second embodiment and organized relationships between the constituents are the same as the functions of the corresponding constituents of the brake control apparatus 100 according to the first embodiment and the organized relationships therebetween. Therefore, a description thereof will be omitted.

The first controller 606 of the brake control apparatus 600 according to the second embodiment further includes a range of pedal stroke according to predetermined reference weight and speed of the vehicle on a reference road condition.

The brake control apparatus 600 further includes a pedal stroke sensing unit 610.

That is, the pedal stroke sensing unit 610 senses a pedal stroke according to the current weight and speed of the vehicle on the current road condition.

Although not shown in FIG. 6, the pedal stroke sensing unit 610 may include a pedal stroke sensor (not shown).

The brake control apparatus 600 further includes a first determination unit 612.

That is, the first determination unit 612 is controlled by the first controller 606 to determine whether the pedal stroke according to the current weight and speed of the vehicle on the current road condition sensed by the pedal stroke sensing unit 610 is within the range of pedal stroke according to predetermined reference weight and speed of the vehicle on the reference road condition.

For example, the first determination unit 612 is controlled by the first controller 606 to determine whether the pedal stroke on at least one of the current road conditions including urban driving, highway driving, level road, and inclined road sensed by the pedal stroke sensing unit 610 is within the range of pedal stroke for at least one of reference road conditions including reference urban driving, reference highway driving, reference level road, and reference inclined road.

The brake control apparatus 600 further includes a first indication unit 614.

That is, when it is determined by the first determination unit 612 that the pedal stroke according to the current weight and speed of the vehicle on the current road condition is within the range of pedal stroke according to predetermined reference weight and speed of the vehicle on the reference road condition, the first indication unit 614 performs an indicating operation to allow selection of a corresponding wheel pressure mode in the wheel pressure selector 102.

Although not shown in FIG. 6, the first indication unit 614 may include at least one of a speaker for the vehicle (not shown) and a light emitting member (not shown). Thereby, the first indication unit 614 may perform an indicating operation to allow selection of a corresponding wheel pressure mode in the wheel pressure selector 102, through at least one of the sound-making operation of the speaker (not shown) and the light emitting operation of the light emitting member (not shown).

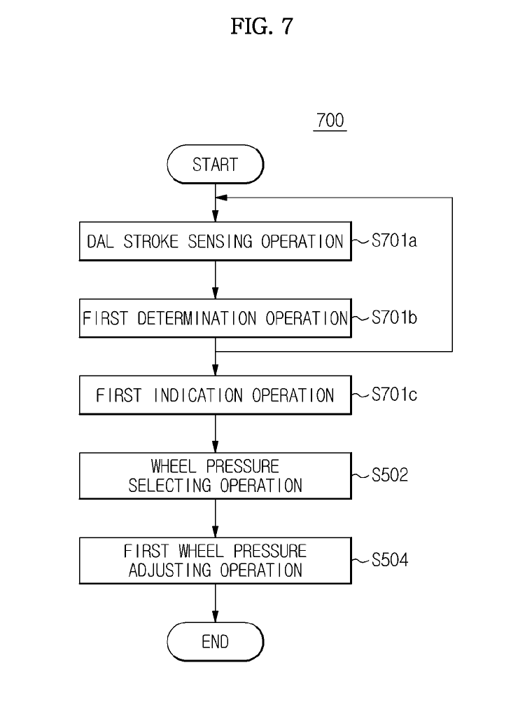

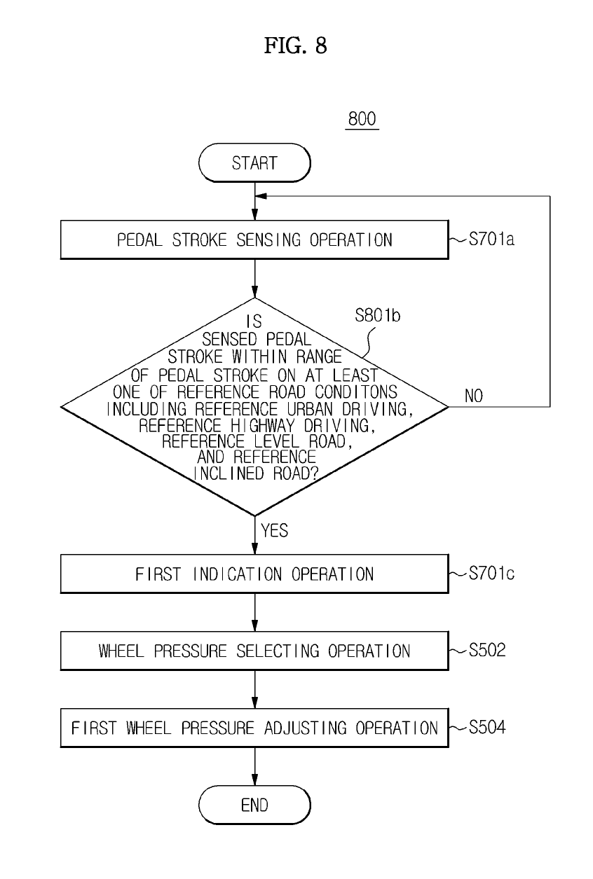

Hereinafter, a method of controlling a brake using the brake control apparatus 600 according to the second embodiment will be described with reference to FIGS. 7 and 8.

FIG. 7 is a flowchart illustrating a brake control method according to the second embodiment, and FIG. 8 is a flowchart illustrating an example of the brake control method according to the second embodiment.

Referring to FIGS. 7 and 8, the brake control method 700, 800 according to the second embodiment include a pedal stroke sensing operation S701a, a first determination operation S701b, S801b, a first indication operation S701c, a wheel pressure selecting operation S502, a first wheel pressure adjusting operation S504.

First, in the pedal stroke sensing operation S701a, the operation of sensing the pedal stroke according to the current weight and speed of the vehicle on the current road condition is performed by the pedal stroke sensing unit 610 (FIG. 6).

Although not shown in FIGS. 7 and 8, in the pedal stroke sensing operation S701a, the pedal stroke sensing unit 610 (FIG. 6) may include a pedal stroke sensor (not shown).

Thereafter, in the first determination operation S701b, S801b, the operation of determining whether the pedal stroke according to the current weight and speed of the vehicle on the current road condition sensed by the pedal stroke sensing unit 610 (FIG. 6) is within the range of pedal stroke according to predetermined reference weight and speed of the vehicle on the reference road condition is performed by the first determination unit 612 (FIG. 6) according to control by the first controller 606 (FIG. 6).

At this time, in the first determination operation S701b, S801b, the operation of setting the range of pedal stroke according to predetermined reference weight and speed of the vehicle on the reference road condition in the first controller 606 (FIG. 6) is performed.

For example, in the first determination operation S701b, S801b, whether the pedal stroke on at least one of the current road conditions including urban driving, highway driving, level road, and inclined road sensed by the pedal stroke sensing unit 610 (FIG. 6) is within the range of pedal stroke for at least one reference road condition of reference urban driving, reference highway driving, reference level road, and reference inclined road is determined by the first determination unit 612 (FIG. 6) according to control by the first controller 606 (FIG. 6).

Thereafter, when it is determined that the pedal stroke according to the current weight and speed of the vehicle on the current road condition determined by the first determination unit 612 (FIG. 6) is within the range of pedal stroke according to predetermined reference weight and speed of the vehicle on the reference road condition, a first indication operation S701c is performed by the first indication unit 614 (FIG. 6) to allow selection of a corresponding wheel pressure mode in the wheel pressure selector 102 (FIG. 6).

Although not shown in FIGS. 7 and 8, in the first indication operation S701c, the first indication unit 614 (FIG. 6) may include at least one of a speaker for the vehicle (not shown) and a light emitting member (not shown), perform an indicating operation to allow selection of a corresponding wheel pressure mode in the wheel pressure selector 102 (FIG. 6), through at least one of the sound-making operation of the speaker (not shown) and the light emitting operation of the light emitting member (not shown).

Thereafter, the wheel pressure selecting operation S502 is performed. In the wheel pressure selecting operation S502, different wheel pressure modes are selected for the current pedal stroke produced in the brake system 10 (FIG. 6) during driving, using the wheel pressure selector 102 (FIG. 6).

For example, in the wheel pressure selecting operation S502, one of the normal mode, the first wheel pressure mode, and the second wheel pressure mode may be selected for the current pedal stroke produced in the brake system 10 (FIG. 6) during driving, using the wheel pressure selector 102 (FIG. 6).

At this time, in the wheel pressure selecting operation S502, the first wheel pressure mode may provide wheel pressure of a level higher than the level of wheel pressure in the normal mode, and the second wheel pressure mode may provide wheel pressure of a level lower than the level of wheel pressure in the normal mode.

Herein, the wheel pressure selector 102 (FIGS. 3 and 6) in the wheel pressure selecting operation S502 may be provided with a rotational lever allowing selecting different wheel pressure modes.

However, embodiments of the present invention are not limited thereto. Although not shown in FIGS. 7 and 8, in the wheel pressure selecting operation S502, the different wheel pressure modes may be selected through one of a push button switch (not shown) and a finger button sensing switch (not shown).

Herein, although not shown in FIGS. 7 and 8, the wheel pressure selector 102 (FIGS. 3 and 6) in the wheel pressure selecting operation S502 may be arranged at one side of the vehicle (not shown) where the wheel pressure selector 102 (FIGS. 3 and 6) does not disturb driving of the vehicle but is easily reachable by the driver's hand.

Finally, in the first wheel pressure adjusting operation S504, the first controller 606 (FIG. 6) receives a wheel pressure mode signal corresponding to one of the wheel pressure modes selected through the wheel pressure selector 102 (FIGS. 3 and 6), and receives, from the wheel pressure storage unit 104 (FIG. 6), wheel pressure information corresponding to the selected wheel pressure mode.

Thereafter, the first wheel pressure adjusting operation S504 is performed. In the first wheel pressure adjusting operation S504, the first wheel pressure adjuster 108 (FIG. 6) supplies, according to control by the first controller 606 (FIG. 6), the corresponding wheel pressure information stored in the wheel pressure storage unit 104 (FIG. 6) to the brake system 10 (FIG. 6) to adjust the current wheel pressure for a current pedal stroke produced in the brake system 10 (FIG. 6) to the corresponding wheel pressure information stored in the wheel pressure storage unit 104 (FIG. 6).

At this time, in the first wheel pressure adjusting operation S504, when one of the wheel pressure modes proper for the pedal stroke according to the current weight and speed of the vehicle on at least one of the current road conditions including urban driving, highway driving, level road, and inclined road is selected through the wheel pressure selector 102 (FIGS. 3 and 6), the first wheel pressure adjuster 108 (FIG. 6) may supply, according to control by the first controller 606 (FIG. 6), the corresponding wheel pressure information stored in the wheel pressure storage unit 104 (FIG. 6) to the brake system 10 (FIG. 6) to adjust the current wheel pressure for a current pedal stroke produced in the brake system 10 (FIG. 6) to the corresponding wheel pressure information stored in the wheel pressure storage unit 104 (FIG. 6).

For example, in the first wheel pressure adjusting operation S504, when the first wheel pressure mode is selected for the pedal stroke according to the current weight and speed of the vehicle on at least one of the current road conditions including urban driving, highway driving, level road, and inclined road through the wheel pressure selector 102 (FIGS. 3 and 6) during driving, the first wheel pressure adjuster 108 (FIG. 4) may supply, according to control by the first controller 606 (FIG. 6), the wheel pressure information including a wheel pressure curve (FIG. 4(b)) stored in the wheel pressure storage unit 104 (FIG. 6) to the brake system 10 (FIG. 6) to adjust the current wheel pressure for a current pedal stroke produced in the brake system 10 (FIG. 6) to the wheel pressure information including the wheel pressure curve (FIG. 4(b)) stored in the wheel pressure storage unit 104 (FIG. 2). In the wheel pressure curve (FIG. 4(b)), the wheel pressure for the pedal stroke [PS(t1)-PS(t2)] (FIG. 4) is gradually restrained for a certain time and after the certain time elapses, the wheel pressure for the pedal stroke [PS(t2)] (FIG. 4) is drastically increased.

At this time, in the first wheel pressure adjusting operation S504, the wheel pressure information may include a wheel pressure curve (FIG. 4(b)), in which the wheel pressure for the pedal stroke [PS(t1)-PS(t2)] (FIG. 4) is gradually restrained for a certain time in the range between 0 bar and 100 bar at which wheel lock is applied, and after the certain time elapses, the wheel pressure for the pedal stroke [PS(t2)] (FIG. 4) is drastically increased up to 200 bar.

Although not shown in FIG. 6, in the first wheel pressure adjusting operation S504, when the second wheel pressure mode is selected through the wheel pressure selector 102 (FIGS. 3 and 6) during driving for the pedal stroke according to the current weight and speed of the vehicle on at least one of the current road conditions including urban driving, highway driving, level road, and inclined road, the first wheel pressure adjuster (not shown) may supply, according to control by the first controller 606 (FIG. 6), supply the wheel pressure information stored in the wheel pressure storage unit 104 (FIG. 2) including levels of wheel pressure lower than the level of the wheel pressure to the brake system 10 (FIG. 6) to adjust the current wheel pressure for the current pedal stroke produced in the brake system 10 (FIG. 6) to the wheel pressure information providing levels of wheel pressure lower than the wheel pressure level in the normal mode, stored in the wheel pressure storage unit 104 (FIG. 6).

The brake control apparatus 600 and control methods 700 and 800 according to the second embodiment include a wheel pressure selector 102, a wheel pressure storage unit 104, a first controller 606, a first wheel pressure adjuster 108, a pedal stroke sensing unit 610, a first determination unit 612, and a first indication unit 614.

Accordingly, to implement the brake control apparatus 600 and control methods 700 and 800 according to the second embodiment, current wheel pressure for a current pedal stroke produced in the brake system 10 is sensed by the pedal stroke sensing unit 610, the indicating operation is performed by the first indication unit 614 such that an optimum wheel pressure level corresponding to the sensed current wheel pressure for the current pedal stroke is selected through the wheel pressure selector 102, and the wheel pressure is adjusted to the corresponding wheel pressure information stored in the wheel pressure storage unit 104 by the first wheel pressure adjuster 108 according to a selection signal from the wheel pressure selector 102.

Thereby, the wheel pressure may be adjusted to the optimum wheel pressure level for the pedal stroke on the current road condition during driving of the vehicle by the brake control apparatus 600 and control methods 700 and 800 according to the second embodiment. Accordingly, power consumption and battery consumption for control of the vehicle may be further reduced, and braking efficiency and driving efficiency may be further improved in consideration of riding comfort.

### Third Embodiment

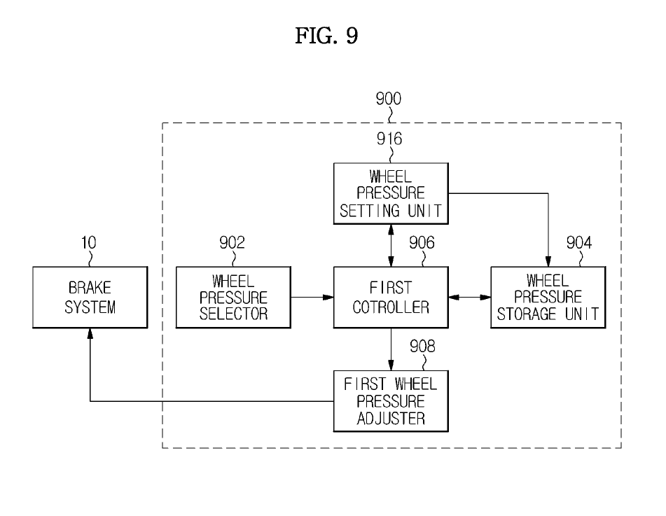

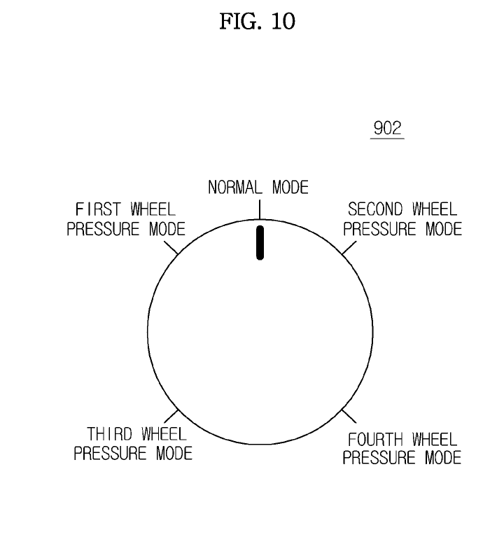

FIG. 9 is a block diagram illustrating an example of a brake control apparatus according to a third embodiment of the present invention, and FIG. 10 is a front view illustrating an example of the wheel pressure selector shown in FIG. 9.

Referring to FIGS. 9 and 10, the brake control apparatus 900 according to the third embodiment includes a wheel pressure selector 902, a wheel pressure storage unit 904, a first controller 906, and a first wheel pressure adjuster 908, which is similar to the brake control apparatus 100 according to the first embodiment.

Functions of the above constituents of the brake control apparatus 900 according to the third embodiment and organized relationships between the constituents are the same as the functions of the corresponding constituents of the brake control apparatus 100 according to the first embodiment and the organized relationships therebetween. Therefore, a description thereof will be omitted.

The brake control apparatus 900 further includes a wheel pressure setting unit 916.

That is, the wheel pressure setting unit 916 is controlled by the first controller 906 to set and store wheel pressure information on another level corresponding to another wheel pressure mode in the wheel pressure storage unit 904 according to the driver's preference.

Herein, the wheel pressure selector 902 allows selecting another wheel pressure mode set by the wheel pressure setting unit 916.

At this time, when another wheel pressure mode set by the wheel pressure setting unit 916 is selected through the wheel pressure selector 902, the first wheel pressure adjuster 908 may adjust the wheel pressure to the wheel pressure information of the another level corresponding to another wheel pressure mode.

For example, as shown in FIG. 10, the wheel pressure selector 902 may allow selecting one of the normal mode, a first wheel pressure mode, a second wheel pressure mode, a third wheel pressure mode, and a fourth wheel pressure mode for a current pedal stroke produced in the brake system 10 during driving.

Herein, the first wheel pressure mode may be a mode providing wheel pressure of a level higher than the level of wheel pressure in the normal mode, and the second wheel pressure mode may be a mode providing wheel pressure of a level lower than the level of wheel pressure in the normal mode.

In addition, the third wheel pressure mode may be a mode providing wheel pressure of a level higher than the wheel pressure level in the first wheel pressure mode, and the fourth wheel pressure mode may be a mode providing wheel pressure of a level lower than the wheel pressure level in the second wheel pressure mode.

Herein, the wheel pressure selector 902 may be provided with a rotational lever allowing selecting different wheel pressure modes.

However, embodiments of the present invention are not limited thereto. Although not shown in FIG. 10, different wheel pressure modes may be selected through the operation of one of a push button switch (not shown) and a finger button sensing switch (not shown).

Herein, although not shown in FIG. 10, the wheel pressure selector 902 may be arranged at one side of the vehicle (not shown) where the wheel pressure selector 902 does not disturb driving of the vehicle but is easily reachable by the driver's hand.

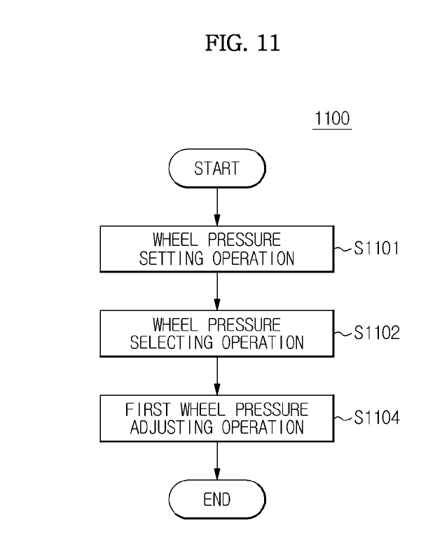

Hereinafter, a brake control method of controlling a brake using the brake control apparatus 900 according to the third embodiment will be described with reference to FIG. 11.

FIG. 11 is a flowchart illustrating a brake control method according to the third embodiment.

Referring to FIG. 11, the brake control method 1100 according to the third embodiment includes a wheel pressure setting operation S1101, a wheel pressure selecting operation S1102, and a first wheel pressure adjusting operation S1104.

First, in the wheel pressure setting operation S1101, the wheel pressure setting unit 916 (FIG. 9) is controlled by the first controller 906 (FIG. 9) to set and store wheel pressure information on another level corresponding to another wheel pressure mode in the wheel pressure storage unit 904 (FIG. 9) according to the driver's preference.

Thereafter, the wheel pressure selecting operation S1102 is performed. In the wheel pressure selecting operation S1102, different wheel pressure modes are selected for the current pedal stroke produced in the brake system 10 (FIG. 10) during driving, using the wheel pressure selector 902 (FIG. 9).

In addition, in the wheel pressure selecting operation S1102, the wheel pressure selector 902 (FIG. 9) is provided to allow selecting another wheel pressure mode set by the wheel pressure setting unit 916 (FIG. 9).

For example, in the wheel pressure selecting operation S1102, the wheel pressure selector 902 (FIG. 10) may allow selecting one of the normal mode, a first wheel pressure mode, a second wheel pressure mode, a third wheel pressure mode, and a fourth wheel pressure mode for a current pedal stroke produced in the brake system 10 (FIG. 9) during driving.

In the wheel pressure selecting operation S1102, the first wheel pressure mode may be a mode providing wheel pressure of a level higher than the level of wheel pressure in the normal mode, and the second wheel pressure mode may be a mode providing wheel pressure of a level lower than the level of wheel pressure in the normal mode.

In addition, in the wheel pressure selecting operation S1102, the third wheel pressure mode may be a mode providing wheel pressure of a level higher than the wheel pressure level in the first wheel pressure mode, and the fourth wheel pressure mode may be a mode providing wheel pressure of a level lower than the wheel pressure level in the second wheel pressure mode.

In the wheel pressure selecting operation S1102, the wheel pressure selector 902 (FIG. 10) may be provided with a rotational lever allowing selecting different wheel pressure modes.

However, embodiments of the present invention are not limited thereto. Although not shown in FIG. 11, in the wheel pressure selecting operation S1102, different wheel pressure modes may be selected through the operation of one of a push button switch (not shown) and a finger button sensing switch (not shown).

Herein, in the wheel pressure selecting operation S1102, although not shown in FIG. 10, the wheel pressure selector 902 (FIG. 10) may be arranged at one side of the vehicle (not shown) where the wheel pressure selector 902 (FIG. 10) does not disturb driving of the vehicle but is easily reachable by the driver's hand.

Finally, in the first wheel pressure adjusting operation S1104, the first controller 906 (FIG. 9) receives a wheel pressure mode signal corresponding to one of the wheel pressure modes selected through the wheel pressure selector 902 (FIGS. 9 and 10), and receives, from the wheel pressure storage unit 904 (FIG. 9), wheel pressure information corresponding to the selected wheel pressure mode.

Thereafter, the first wheel pressure adjusting operation S1104 is performed. In the first wheel pressure adjusting operation S1104, the first wheel pressure adjuster 908 (FIG. 9) supplies, according to control by the first controller 906 (FIG. 9), the corresponding wheel pressure information stored in the wheel pressure storage unit 904 (FIG. 9) to the brake system 10 (FIG. 9) to adjust the current wheel pressure for a current pedal stroke produced in the brake system 10 (FIG. 9) to the corresponding wheel pressure information stored in the wheel pressure storage unit 904 (FIG. 9).

At this time, in the first wheel pressure adjusting operation S1104, when one of the wheel pressure modes proper for the pedal stroke according to the current weight and speed of the vehicle on at least one of the current road conditions including urban driving, highway driving, level road, and inclined road is selected through the wheel pressure selector 902 (FIGS. 9 and 10), the first wheel pressure adjuster 908 (FIG. 9) may supply, according to control by the first controller 906 (FIG. 9), the corresponding wheel pressure information stored in the wheel pressure storage unit 904 (FIG. 9) to the brake system 10 (FIG. 9) to adjust the current wheel pressure for a current pedal stroke produced in the brake system 10 (FIG. 9) to the corresponding wheel pressure information stored in the wheel pressure storage unit 904 (FIG. 9).

For example, in the first wheel pressure adjusting operation S1104, when the first wheel pressure mode is selected for the pedal stroke according to the current weight and speed of the vehicle on at least one of the current road conditions including urban driving, highway driving, level road, and inclined road through the wheel pressure selector 902 (FIG. 10) during driving, the first wheel pressure adjuster 908 (FIG. 9) may supply, according to control by the first controller 906 (FIG. 9), the wheel pressure information including a wheel pressure curve (FIG. 4(b)) stored in the wheel pressure storage unit 904 (FIG. 9) to the brake system 10 (FIG. 9) to adjust the current wheel pressure for the current pedal stroke produced in the brake system 10 (FIG. 9) to the wheel pressure information including the wheel pressure curve (FIG. 4(b)) stored in the wheel pressure storage unit 904 (FIG. 9). In the wheel pressure curve (FIG. 4(b)), the wheel pressure for the pedal stroke [PS(t1)-PS(t2)] (FIG. 4) is gradually restrained for a certain time and after the certain time elapses, the wheel pressure for the pedal stroke [PS(t2)] (FIG. 4) is drastically increased.

At this time, in the first wheel pressure adjusting operation S1104, the wheel pressure information may include a wheel pressure curve (FIG. 4(b)), in which the wheel pressure for the pedal stroke [PS(t1)-PS(t2)] (FIG. 4) is gradually restrained for a certain time in the range between 0 bar and 100 bar at which wheel lock is applied, and after the certain time elapses, the wheel pressure for the pedal stroke [PS(t2)] (FIG. 4) is drastically increased up to 200 bar.

Although not shown in FIG. 11, in the first wheel pressure adjusting operation S1104, when the second wheel pressure mode is selected through the wheel pressure selector 902 (FIG. 10) during driving for the pedal stroke according to the current weight and speed of the vehicle on at least one of the current road conditions including urban driving, highway driving, level road, and inclined road, the first wheel pressure adjuster (not shown) may supply, according to control by the first controller 906 (FIG. 9), supply the wheel pressure information stored in the wheel pressure storage unit 904 (FIG. 9) including levels of wheel pressure lower than the level of the wheel pressure to the brake system 10 (FIG. 9) to adjust the current wheel pressure for the current pedal stroke produced in the brake system 10 (FIG. 9) to the wheel pressure information including levels of wheel pressure lower than the wheel pressure level in the normal mode, stored in the wheel pressure storage unit 904 (FIG. 9).

In addition, in the first wheel pressure adjusting operation S1104, when another wheel pressure mode set by the wheel pressure setting unit 916 (FIG. 9) selected through the wheel pressure selector 902 (FIGS. 9 and 10), the first wheel pressure adjuster 908 (FIG. 9) may adjust the wheel pressure to the wheel pressure information of the another level corresponding to another wheel pressure mode.

At this time, although not shown in FIG. 11, in the first wheel pressure adjusting operation S1104, when the third wheel pressure mode or the fourth wheel pressure mode is selected through the wheel pressure selector 902 (FIG. 10) during driving for the pedal stroke according to the current weigh and speed of the vehicle on at least one of the current road conditions including urban driving, highway driving, level road, and inclined road, the corresponding wheel pressure information providing wheel pressure of a level higher than the wheel pressure level in the first wheel pressure mode or the wheel pressure level in the second wheel pressure mode stored in the wheel pressure storage unit 904 (FIG. 9) may be supplied from the first wheel pressure adjuster (not shown) to the brake system 10 (FIG. 9) according to control by the first controller 906 (FIG. 9) to adjust the current wheel pressure for the current pedal stroke produced in the brake system 10 (FIG. 9) to the wheel pressure information providing wheel pressure of a level higher than the wheel pressure level in the first wheel pressure mode or the wheel pressure level in the second wheel pressure mode, stored in the wheel pressure storage unit 904 (FIG. 9).

As described above, the brake control apparatus 900 and control method 1100 according to the third embodiment include the wheel pressure selector 902, the wheel pressure storage unit 904, the first controller 906, the first wheel pressure adjuster 908, and the wheel pressure setting unit 916.

Accordingly, to implement the brake control apparatus 900 and control method 1100 according to the third embodiment, current wheel pressure for a current pedal stroke produced in the brake system 10 is selected through the wheel pressure selector 902, and the wheel pressure is adjusted to the corresponding wheel pressure information stored in the wheel pressure storage unit 904 by the first wheel pressure adjuster 908 according to a selection signal from the wheel pressure selector 902.

Thereby, the wheel pressure may be adjusted to the proper wheel pressure level for the pedal stroke on the current road condition during driving of the vehicle by the brake control apparatus 900 and control method 1100 according to the third embodiment. Accordingly, power consumption and battery consumption for control of the vehicle may be reduced, and braking efficiency and driving efficiency may be improved in consideration of riding comfort.

In addition, according to the brake control apparatus 900 and control method 1100, the wheel pressure setting unit 916 sets and stores wheel pressure information on another level corresponding to another wheel pressure mode in the wheel pressure storage unit 904 according to the driver's preference, and the first wheel pressure adjuster 908 adjusts the current wheel pressure to the corresponding wheel pressure information stored in the wheel pressure storage unit 904 according to the selection signal from the wheel pressure selector 902.

According to the brake control apparatus 900 and control method 1100, the drive is allowed to set the wheel pressure level for the pedal stroke on the current road condition during driving, and therefore the riding comfort may be further enhanced.

### Fourth Embodiment

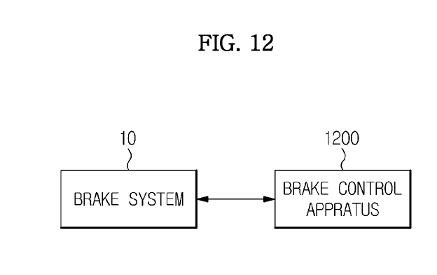

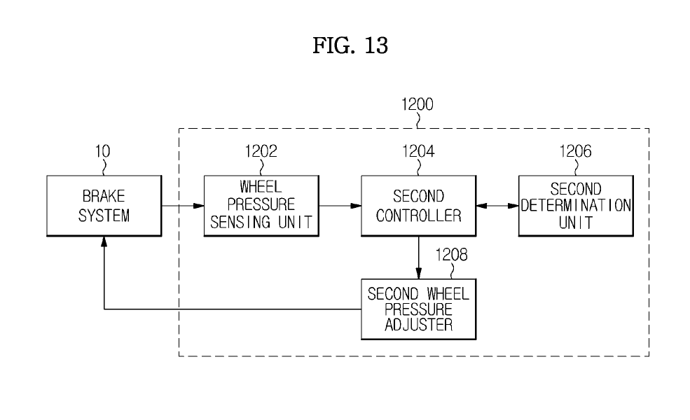

FIG. 12 is a block diagram illustrating a brake control apparatus according to a fourth embodiment of the present invention and a brake system connected thereto, and FIG. 13 is a block diagram illustrating an example of the brake control apparatus shown in FIG. 12.

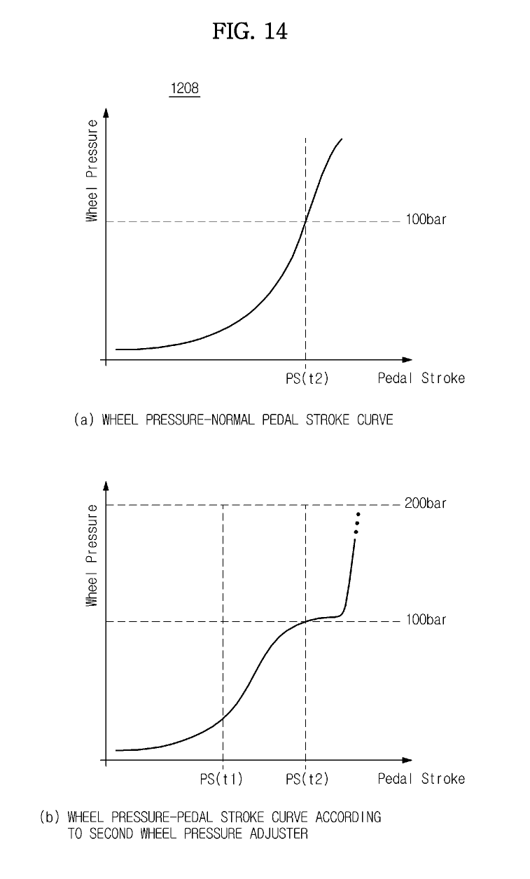

FIG. 14 is a graph showing a wheel pressure-normal pedal stroke curve in the second wheel pressure adjuster shown in FIG. 13 and an example of the wheel pressure-pedal stroke curve produced by the second wheel pressure adjuster.

Referring to FIGS. 12 to 14, the brake control apparatus 1200 according to the fourth embodiment includes a wheel pressure sensing unit 1202, a second controller 1204, a second determination unit 1206, and a second wheel pressure adjuster 1208.

The wheel pressure sensing unit 1202 senses current wheel pressure for a current pedal stroke produced in the brake system 10 on the current road condition according to the weight and speed of the vehicle during driving.

Although not shown in FIGS. 12 to 14, the wheel pressure sensing unit 1202 may include a wheel pressure sensor (not shown) to sense current wheel pressure according to the current pedal stroke.

The second controller 1204 receives the current wheel pressure for the current pedal stroke sensed by the wheel pressure sensing unit 1202, and includes wheel pressure information corresponding to the range of reference wheel pressure for a predetermined reference pedal stroke, to which the current pressure is adjusted.

The second determination unit 1206 is controlled by the second controller 1204 to determine whether the current wheel pressure for the current pedal stroke sensed by the wheel pressure sensing unit 1202 is within the range of reference wheel pressure for a predetermined reference pedal stroke.

At this time, the second determination unit 1206 may be controlled by the second controller 1204 to determine whether the current wheel pressure, sensed by the wheel pressure sensing unit 1202, for the pedal stroke according to the current weight and speed of the vehicle on at least one of the current road conditions including urban driving, highway driving, level road, and inclined road is within the range of reference wheel pressure for the pedal stroke according to the reference weight and speed of the vehicle on at least one of the reference road conditions including reference urban driving, reference highway driving, reference level road, and reference inclined road.

When it is determined by the second determination unit 1206 that the current wheel pressure for the current pedal stroke is within the range of the reference wheel pressure for a predetermined reference pedal stroke, the second wheel pressure adjuster 1208 is controlled by the second controller 1204 to supply the wheel pressure information corresponding to the range of reference wheel pressure for a predetermined reference pedal stroke to the brake system 10 to adjust the current wheel pressure for the current pedal stroke produced in the brake system 10 to the wheel pressure information, according to control by the second controller 1204.

For example, as shown in FIG. 14, when it is determined by the second determination unit 1206 that the current wheel pressure for the pedal stroke according to the current weight and speed of the vehicle on at least one of the current road conditions including urban driving, highway driving, level road, and inclined road is within the range of reference wheel pressure for the pedal stroke according to the reference weight and speed of the vehicle on at least one of the reference road conditions including reference urban driving, reference highway driving, reference level road, and reference inclined road, the wheel pressure information including a wheel pressure curve (FIG. 14(b)) may be supplied, according to control by the second controller 1204, from the second wheel pressure adjuster 1208 to the brake system 10 to adjust the current wheel pressure for the current pedal stroke produced in the brake system 10 to the wheel pressure information, according to control by the second controller 1204. Referring to the wheel pressure curve (FIG. 14(b)), the wheel pressure for the pedal stroke [PS(t1)-PS(t2)] is gradually restrained for a certain time and after the certain time elapses, the wheel pressure for the pedal stroke [PS(t2)] is drastically increased.

Herein, the wheel pressure information may include a wheel pressure curve (FIG. 14(b)), in which the wheel pressure for the pedal stroke [PS(t1)-PS(t2)] is gradually restrained for a certain time in the range between 0 bar and 100 bar at which wheel lock is applied, and after the certain time elapses, the wheel pressure for the pedal stroke [PS(t2)] is drastically increased up to 200 bar.

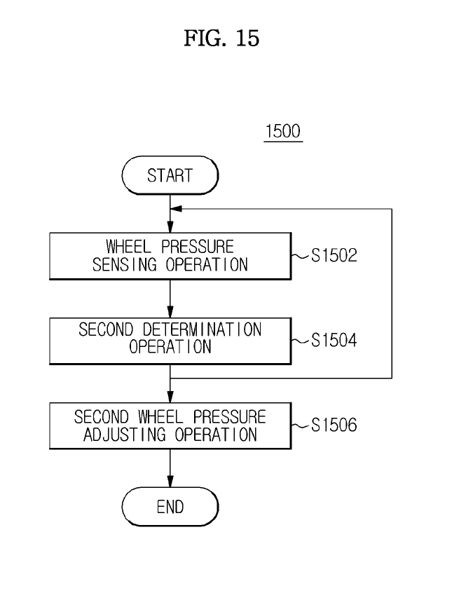

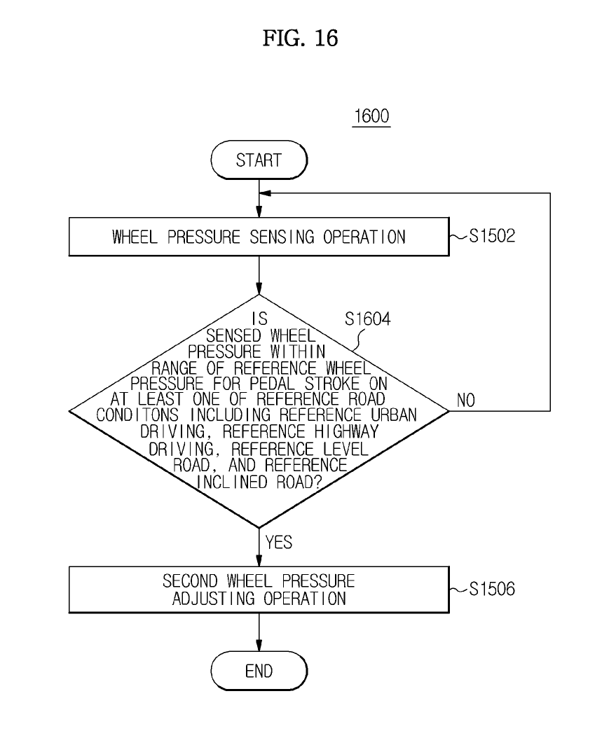

Control methods 1500 and 1600 to control a brake using the brake control apparatus 1200 according to the fourth embodiment are illustrated in FIGS. 15 and 16.

FIG. 15 is a flowchart illustrating a brake control method according to a fourth embodiment of the present invention, and FIG. 16 is a flowchart illustrating an example of the brake control method according to the fourth embodiment.

Referring to FIGS. 15 and 16, the brake control method 1500, 1600 according to the fourth embodiment includes a wheel pressure sensing operation S1502, a second determination operation S1504, S1604, and a second wheel pressure adjusting operation S1506.

First, in the wheel pressure sensing operation S1502, the operation of sensing the current pressure for a current pedal stroke produced in the brake system 10 (FIG. 13) according to the current weight and speed on the current road condition is performed by the sensing the wheel pressure sensing unit 1202 (FIG. 13).

Although not shown in FIGS. 15 and 16, in the wheel pressure sensing operation S1502, the wheel pressure sensing unit 1202 (FIG. 13) may include a wheel pressure sensor (not shown) to sense the current wheel pressure according to the current pedal stroke.

Thereafter, in the second determination operation S1504, S1604, the operation of determining whether the current wheel pressure for the current pedal stroke sensed by the wheel pressure sensing unit 1202 (FIG. 13) is within the range of reference wheel pressure for a predetermined reference pedal stroke set in the second controller 1204 (FIG. 13) is performed by the second determination unit 1206 (FIG. 13) according to control by the second controller 1204 (FIG. 13).

At this time, in the second determination operation S1504, S1604, the operation of determining whether the current wheel pressure, sensed by the wheel pressure sensing unit 1202 (FIG. 13), for the pedal stroke according to the current weight and speed of the vehicle on at least one of the current road conditions including urban driving, highway driving, level road, and inclined road is within the range of reference wheel pressure for the pedal stroke according to the reference weight and speed of the vehicle on at least one of the reference road conditions including reference urban driving, reference highway driving, reference level road, and reference inclined road may be performed by the second determination unit 1206 (FIG. 13) according to control by the second controller 1204 (FIG. 13).

Finally, the second wheel pressure adjusting operation S1506 is performed. When it is determined by the second determination unit 1206 (FIG. 13) that the current wheel pressure for the current pedal stroke is within the range of reference wheel pressure for a predetermined reference pedal stroke, the operation of supplying the wheel pressure information corresponding to the range of reference wheel pressure for a predetermined reference pedal stroke set in the second controller 1204 (FIG. 13) to the brake system 10 (FIG. 13) and adjusting the current wheel pressure for the current pedal stroke produced in the brake system 10 (FIG. 13) to the wheel pressure information is performed by the second wheel pressure adjuster 1208 (FIG. 13) according to control by the second controller 1204 (FIG. 13).

For example, when it is determined by the second determination unit 1206 (FIG. 13) that the current wheel pressure for the pedal stroke according to the current weight and speed of the vehicle on at least one of the current road conditions including urban driving, highway driving, level road, and inclined road is within the range of reference wheel pressure for the pedal stroke according to the reference weight and speed of the vehicle on at least one of the reference road conditions including reference urban driving, reference highway driving, reference level road, and reference inclined road, the operation of supplying the wheel pressure information including a wheel pressure curve (FIG. 14(b)) to the brake system 10 (FIG. 13) and adjusting the current wheel pressure for the current pedal stroke produced in the brake system 10 (FIG. 13) to the wheel pressure information may be performed by the second wheel pressure adjuster 1208 (FIG. 13) according to control by the second controller 1204 (FIG. 13) in the second wheel pressure adjusting operation S1506. The wheel pressure curve (FIG. 14(b)) shows that the wheel pressure for the pedal stroke [PS(t1)-PS(t2)] is gradually restrained for a certain time and after the certain time elapses, the wheel pressure for the pedal stroke [PS(t2)] is drastically increased.

Herein, in the second wheel pressure adjusting operation S1506, the wheel pressure information may include a wheel pressure curve (FIG. 14(b)), in which the wheel pressure for the pedal stroke [PS(t1)-PS(t2)] is gradually restrained for a certain time in the range between 0 bar and 100 bar at which wheel lock is applied, and after the certain time elapses, the wheel pressure for the pedal stroke [PS(t2)] is drastically increased up to 200 bar.

As described above, the brake control apparatus 1200 and control methods 1500 and 1600 according to the fourth embodiment include the wheel pressure sensing unit 1202, the second controller 1204, the second determination unit 1206, and the second wheel pressure adjuster 1208.

Accordingly, in the brake control apparatus 1200 and control methods 1500 and 1600, the current wheel pressure for a current pedal stroke produced in the brake system 10 is sensed by the wheel pressure sensing unit 1202 and adjusted to the wheel pressure information by the second wheel pressure adjuster 1208.

Thereby, the brake control apparatus 1200 and control methods 1500 and 1600 may automatically adjust the current wheel pressure to a wheel pressure level proper for the pedal stroke produced on the current road condition during driving. Therefore, power consumption and battery consumption for control of the vehicle may be reduced, and braking efficiency and driving efficiency may be improved in consideration of riding comfort.

### Fifth Embodiment

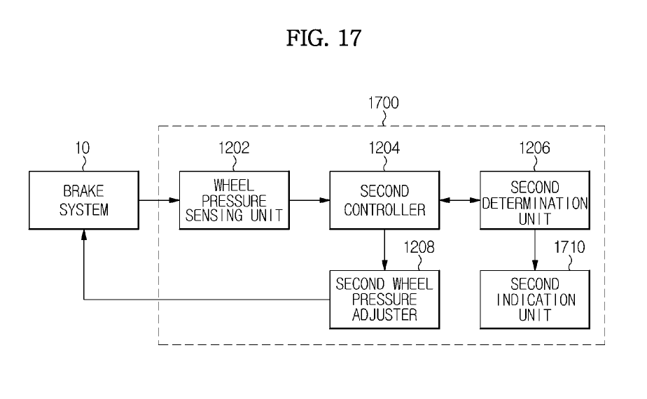

FIG. 17 is a block diagram illustrating an example of a brake control apparatus according to a fifth embodiment of the present invention.

Referring to FIG. 17, the brake control apparatus 1700 according to the fifth embodiment includes a wheel pressure sensing unit 1202, a second controller 1204, a second determination unit 1206, and a second wheel pressure adjuster 1208, which are the same as those of the brake control apparatus 1200 according to the fourth embodiment.

Functions of the above constituents of the brake control apparatus 1700 according to the fifth embodiment and organized relationships between the constituents are the same as the functions of the corresponding constituents of the brake control apparatus 1200 according to the fourth embodiment and the organized relationships therebetween. Therefore, a description thereof will be omitted.

The brake control apparatus 1700 further includes a second indication unit 1710.

That is, when it is determined by the second determination unit 1206 that the current wheel pressure for the current pedal stroke is within the range of reference wheel pressure for a predetermined reference pedal stroke, the second indication unit 1710 indicates the condition for the wheel pressure corresponding to the wheel pressure information to which the current wheel pressure is adjusted.

Although not shown in FIG. 17, the second indication unit 1710 may include at least one of a speaker for the vehicle (not shown) and a light emitting member (not shown). Thereby, the second indication unit 1710 may indicate the condition for the wheel pressure corresponding to the wheel pressure information to which the current wheel pressure is adjusted, through at least one of the sound-making operation of the speaker (not shown) and the light emitting operation of the light emitting member (not shown).

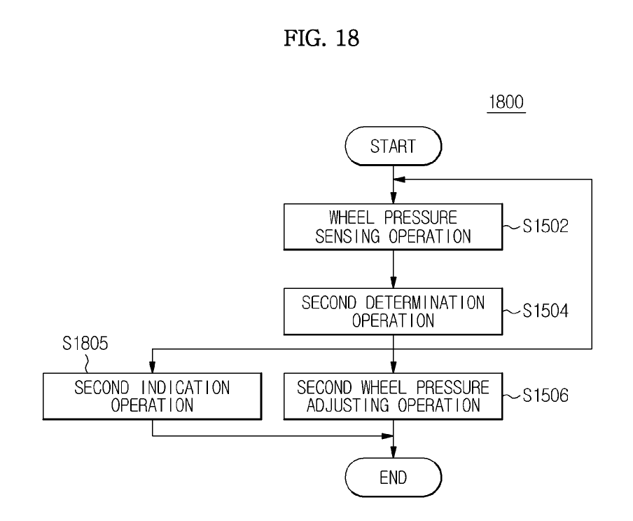

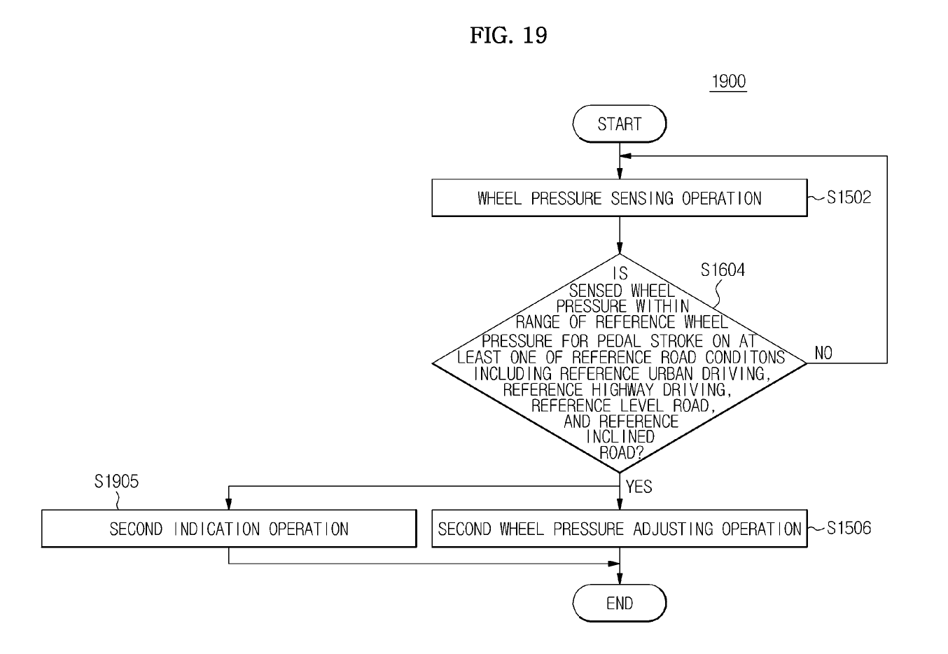

Hereinafter, the methods 1800 and 1900 of controlling a brake using the brake control apparatus will be described with reference to FIGS. 18 and 19.

FIG. 18 is a flowchart illustrating a brake control method according to the fifth embodiment, and FIG. 19 is a flowchart illustrating an example of the brake control method according to the fifth embodiment.

Referring to FIGS. 18 and 19, the brake control method 1800, 1900 includes a wheel pressure sensing operation S1502, a second determination operation S1504, S1604, a second indication operation S1805, S1905, and a second wheel pressure adjusting operation S1506.

First, the wheel pressure sensing operation S1502 is performed. In the wheel pressure sensing operation S1502, the operation of sensing the current pressure for a current pedal stroke produced in the brake system 10 (FIG. 17) according to the current weight and speed on the current road condition is performed by the sensing the wheel pressure sensing unit 1202 (FIG. 17).

Although not shown in FIGS. 18 and 19, in the wheel pressure sensing operation S1502, the wheel pressure sensing unit 1202 (FIG. 17) may include a wheel pressure sensor (not shown) to sense the current wheel pressure according to the current pedal stroke.

Thereafter, in the second determination operation S1504, S1604, the operation of determining whether the current wheel pressure for the current pedal stroke sensed by the wheel pressure sensing unit 1202 (FIG. 17) is within the range of reference wheel pressure for a predetermined reference pedal stroke set in the second controller 1204 (FIG. 17) is performed by the second determination unit 1206 (FIG. 17) according to control by the second controller 1204 (FIG. 17).

At this time, in the second determination operation S1504, S1604, the operation of determining whether the current wheel pressure, sensed by the wheel pressure sensing unit 1202 (FIG. 17), for the pedal stroke according to the current weight and speed of the vehicle on at least one of the current road conditions including urban driving, highway driving, level road, and inclined road is within the range of reference wheel pressure for the pedal stroke according to the reference weight and speed of the vehicle on at least one of the reference road conditions including reference urban driving, reference highway driving, reference level road, and reference inclined road may be performed by the second determination unit 1206 (FIG. 17) according to control by the second controller 1204 (FIG. 17).

Thereafter, the second indication operation S1805, S1905 is performed. When it is determined by the second determination unit 1206 (FIG. 17) that the current wheel pressure for the current pedal stroke is within the range of reference wheel pressure for a predetermined reference pedal stroke, the operation of indicating the condition for the wheel pressure corresponding to the wheel pressure information to which the current wheel pressure is adjusted is performed by the second indication unit 1710 (FIG. 17) in the second indication operation S1805, S1905.

Although not shown in FIGS. 18 and 19, in the second indication operation S1805, S1905, the second indication unit 1710 (FIG. 17) may include at least one of a speaker for the vehicle (not shown) and a light emitting member (not shown). Thereby, the second indication unit 1710 (FIG. 17) may indicate the condition for the wheel pressure corresponding to the wheel pressure information to which the current wheel pressure is adjusted, through at least one of the sound-making operation of the speaker (not shown) and the light emitting operation of the light emitting member (not shown).

Finally, the second wheel pressure adjusting operation S1506 is performed. When it is determined by the second determination unit 1206 (FIG. 17) that the current wheel pressure for the current pedal stroke is within the range of reference wheel pressure for a predetermined reference pedal stroke, the second wheel pressure adjusting operation S1506 of supplying the wheel pressure information corresponding to the range of reference wheel pressure for a predetermined reference pedal stroke set in the second controller 1204 (FIG. 17) to the brake system 10 (FIG. 17) and adjusting the current wheel pressure for the current pedal stroke produced in the brake system 10 (FIG. 17) to the wheel pressure information is performed by the second wheel pressure adjuster 1208 (FIG. 17) according to control by the second controller 1204 (FIG. 17).

For example, when it is determined by the second determination unit 1206 (FIG. 17) that the current wheel pressure for the pedal stroke according to the current weight and speed of the vehicle on at least one of the current road conditions including urban driving, highway driving, level road, and inclined road is within the range of reference wheel pressure for the pedal stroke according to the reference weight and speed of the vehicle on at least one of the reference road conditions including reference urban driving, reference highway driving, reference level road, and reference inclined road, the operation of supplying the wheel pressure information including a wheel pressure curve (FIG. 14(b)) to the brake system 10 (FIG. 17) and adjusting the current wheel pressure for the current pedal stroke produced in the brake system 10 (FIG. 17) to the wheel pressure information may be performed by the second wheel pressure adjuster 1208 (FIG. 17) according to control by the second controller 1204 (FIG. 17) in the second wheel pressure adjusting operation S1506. The wheel pressure curve (FIG. 14(b)) shows that the wheel pressure for the pedal stroke [PS(t1)-PS(t2)] is gradually restrained for a certain time and after the certain time elapses, the wheel pressure for the pedal stroke [PS(t2)] is drastically increased.

Herein, in the second wheel pressure adjusting operation S1506, the wheel pressure information may include a wheel pressure curve (FIG. 14(b)), in which the wheel pressure for the pedal stroke [PS(t1)-PS(t2)] is gradually restrained for a certain time in the range between 0 bar and 100 bar at which wheel lock is applied, and after the certain time elapses, the wheel pressure for the pedal stroke [PS(t2)] is drastically increased up to 200 bar.

As described above, the brake control apparatus 1700 and control methods 1800 and 1900 according to the fifth embodiment include the wheel pressure sensing unit 1202, the second controller 1204, the second determination unit 1206, the second wheel pressure adjuster 1208, and the second indication unit 1710.

Accordingly, in the brake control apparatus 1700 and control methods 1800 and 1900, the current wheel pressure for a current pedal stroke produced in the brake system 10 is sensed by the wheel pressure sensing unit 1202, and the condition for the wheel pressure corresponding to the wheel pressure information to which the current wheel pressure is adjusted is indicated by the second indication unit 1710. Thereby, the current wheel pressure is adjusted to the wheel pressure information by the second wheel pressure adjuster 1208.

Thereby, the brake control apparatus 1700 and control methods 1800 and 1900 may indicate the condition of the wheel pressure corresponding to the pedal stroke on the current road condition and automatically adjust the current wheel pressure to a wheel pressure level proper for the pedal stroke produced on the current road condition during driving. Therefore, power consumption and battery consumption for control of the vehicle may be reduced, and braking efficiency and driving efficiency may be improved in consideration of riding comfort.

As is apparent from the above description, a brake control apparatus and method according to the present invention may reduce power consumption and battery consumption for control of a vehicle and improve braking efficiency and driving efficiency in consideration of riding comfort.

In addition, a brake control apparatus and method according to the present invention may provide the driver with comfortable ride.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A brake control apparatus comprising:
a wheel pressure selector to select one of a plurality of different wheel pressure modes for a current pedal stroke produced in a brake system during driving of a vehicle;
a wheel pressure storage unit to store information on a plurality of different levels of wheel pressure corresponding to the different wheel pressure modes;
a first controller to receive a wheel pressure mode signal corresponding to one of the wheel pressure modes selected through the wheel pressure selector and to control the wheel pressure storage unit to receive corresponding wheel pressure information from the wheel pressure storage unit; and
a first wheel pressure adjuster to supply the corresponding wheel pressure information stored in the wheel pressure storage unit to brake system according to control by the first controller to adjust a current wheel pressure for the current pedal stroke produced in the brake system to the corresponding wheel pressure information stored in the wheel pressure storage unit.

2. The brake control apparatus according to claim 1, wherein the first controller includes a range of a pedal stroke on a reference road condition according to a predetermined reference weight and reference speed of the vehicle,
the brake control apparatus further comprising:
a pedal stroke sensing unit to sense a pedal stroke on a current road condition according to a current weight and current speed of the vehicle during driving of the vehicle;
a first determination unit to determine, according to control by the first controller, whether the pedal stroke on the current road condition according to the current weight and current speed of the vehicle sensed by the pedal stroke sensing unit is within the range of the pedal stroke on the reference road condition according to the reference weight and reference speed of the vehicle; and
a first indication unit to indicate, when the pedal stroke on the current road condition according to the current weight and current speed of the vehicle determined by the first determination unit is within the range of the pedal stroke on the reference road condition according to the reference weight and reference speed of the vehicle, a corresponding wheel pressure mode of the wheel pressure selector to allow selecting of the corresponding wheel pressure mode.

3. The brake control apparatus according to claim 1, further comprising a wheel pressure setting unit to set and store, according to control by the first controller, wheel pressure information on another level of wheel pressure corresponding to another wheel pressure mode in the wheel pressure storage unit in accordance with a preference of a driver of the vehicle,
wherein the anther wheel pressure mode set by the wheel pressure setting unit is selectable through the wheel pressure selector.

4. A brake control apparatus comprising:
a wheel pressure sensing unit to sense a current wheel pressure for a current pedal stroke produced in a brake system on a current road condition according to a weight and speed of a vehicle during driving of the vehicle;
a second controller to receive a current wheel pressure for the current pedal stroke sensed by the wheel pressure sensing unit, the second controller including wheel pressure information corresponding to a range of a reference wheel pressure for a predetermined reference pedal stroke;
a second determination unit to determine, according to control by the second controller, whether the current wheel pressure for the current pedal stroke sensed by the wheel pressure sensing unit is within the range of the reference wheel pressure for the reference pedal stroke; and
a second wheel pressure adjuster to supply, when the current wheel pressure for the current pedal stroke determined by the second determination unit is within the range of the reference wheel pressure for the reference pedal stroke, the wheel pressure information corresponding to the range of the reference wheel pressure for the reference pedal stroke to the brake system to the brake system according to control by the second controller to adjust the current wheel pressure for the current pedal stroke produced in the brake system to the wheel pressure information according to control by the second controller.

5. The brake control apparatus according to claim 4, further comprising a second indication unit to indicate a condition for a wheel pressure corresponding to the wheel pressure information when the current wheel pressure for the current pedal stroke determined by the second determination unit is within the range of the reference wheel pressure for the reference pedal stroke.

6. A method of controlling a brake comprising:
a wheel pressure selecting operation of selecting one of a plurality of different wheel pressure modes for a current pedal stroke produced in a brake system during driving of a vehicle, using a wheel pressure selector; and
a first wheel pressure adjusting operation of receiving, by a first controller, a wheel pressure mode signal corresponding to one of the wheel pressure modes selected through the wheel pressure selector, receiving, by the first controller, wheel pressure information corresponding to the selected one of one of the wheel pressure modes from a wheel pressure storage unit, supplying, a first wheel pressure adjuster, the corresponding wheel pressure information stored in the wheel pressure storage unit to the brake system to adjust a current wheel pressure for the current pedal stroke produced in the brake system to the corresponding wheel pressure information stored in the wheel pressure storage unit according to control by the first controller.

7. The method according to claim 6, wherein the first controller includes a range of a pedal stroke on a reference road condition according to a reference weight and reference speed of the vehicle,
the method further comprising:
a pedal stroke sensing operation of sensing, by a pedal stroke sensing unit, a pedal stroke on a current road condition according to a current weight and current speed of the vehicle during driving of the vehicle;
a first determination operation of determine, by a first determination unit, whether the pedal stroke on the current road condition according to the current weight and current speed of the vehicle sensed by the pedal stroke sensing unit is within the range of the pedal stroke on the reference road condition according to the reference weight and reference speed of the vehicle according to control by the first controller; and
a first indication operation of indicating, by a first indication unit when the pedal stroke on the current road condition according to the current weight and current speed of the vehicle determined by the first determination unit is within the range of the pedal stroke on the reference road condition according to the reference weight and reference speed of the vehicle, a corresponding wheel pressure mode of the wheel pressure selector to allow selecting of the corresponding wheel pressure mode,
wherein the pedal stroke sensing operation, the first determination operation, and the first indication operation are performed prior to the wheel pressure selecting operation.

8. The method according to claim 6, further comprising a wheel pressure setting operation of setting and storing, by a wheel pressure setting unit, wheel pressure information on another level of wheel pressure corresponding to another wheel pressure mode in the wheel pressure storage unit in accordance with a preference of a driver of the vehicle, according to control by the first controller,
wherein the wheel pressure setting operation is performed prior to the wheel pressure selecting operation,
wherein the anther wheel pressure mode set by the wheel pressure setting unit is selectable through the wheel pressure selector.

9. A method of controlling a brake comprising:
a wheel pressure sensing operation of sensing, by a wheel pressure sensing unit, a current wheel pressure for a current pedal stroke produced in a brake system on a current road condition according to a weight and speed of a vehicle during driving of the vehicle;
a second determination operation of determining, by a second determination unit, whether the current wheel pressure for the current pedal stroke sensed by the wheel pressure sensing unit is within a range of a reference wheel pressure for a predetermined reference pedal stroke set in a second controller, according to control by the second controller; and
a second wheel pressure adjusting operation of supplying, by a second wheel pressure adjuster when the current wheel pressure for the current pedal stroke determined by the second determination unit is within the range of the reference wheel pressure for the reference pedal stroke, the wheel pressure information corresponding to the range of the reference wheel pressure for the reference pedal stroke to the brake system to the brake system according to control by the second controller to adjust the current wheel pressure for the current pedal stroke produced in the brake system to the wheel pressure information according to control by the second controller.

10. The method according to claim 9, further comprising a second indication operation of indicating, by a second indication unit, a condition for a wheel pressure corresponding to the wheel pressure information when the current wheel pressure for the current pedal stroke determined by the second determination unit is within the range of the reference wheel pressure for the reference pedal stroke
wherein the second indication operation is performed after the second determination operation.
